(19) United States
(12) Patent Application Publication
(10) Pub. No.: US 2024/0054680 A1
(43) Pub. Date: Feb. 15, 2024

(54) METHOD, APPARATUS AND PROGRAM FOR PROVIDING PERSONAL COLOR DIAGNOSIS PLATFORM USING IMAGE

(71) Applicant: BLACK TANGERINE CORP., Seoul (KR)

(72) Inventor: Sang E KIM, Seoul (KR)

(73) Assignee: BLACK TANGERINE CORP., Seoul (KR)

(21) Appl. No.: 18/492,965

(22) Filed: Oct. 24, 2023

Related U.S. Application Data
(63) Continuation of application No. PCT/KR2023/002427, filed on Feb. 21, 2023.

(30) Foreign Application Priority Data
Feb. 23, 2022 (KR) 10-2022-0023627
Feb. 23, 2022 (KR) 10-2022-0023628

(51) Int. Cl. G06T 7/90; G06V 40/16; G06V 10/56; G06T 7/11; G06Q 30/0601

(52) U.S. Cl. CPC G06T 7/90; G06V 40/171; G06V 10/56; G06T 7/11; G06Q 30/0631; G06T 2207/30201; G06T 2207/30088; G06T 2207/10024; G06T 2207/20021; G06V 10/764

(57) ABSTRACT

The present invention relates to a method, apparatus, and program for providing a personal color diagnosis platform using an image, through which it is possible to analyze a skin color of a user using a captured image of the user's face, diagnose a personal color matching the skin color, and provide the user with the diagnosed personal color. The method of providing a personal color diagnosis platform using an image according to an embodiment of the present invention includes acquiring a captured image of a user's face, dividing the face in the image, extracting a skin color of a designated area from the divided face, and extracting a color matching the user based on the extracted skin color.

### CROSS-REFERENCE TO RELATED APPLICATION

This application is a continuation of PCT/KR2023/002427, filed on Feb. 21, 2023, which claims priority to and the benefit of Korean Patent Application Nos. 10-2022-0023627 and 10-2022-0023628 both filed on Feb. 23, 2022, the disclosure of which is incorporated herein by reference in its entirety.

### BACKGROUND

### 1. Field of the Invention

The present invention relates to a method, apparatus, and program for providing a personal color diagnosis platform using an image, and more particularly, to a method, apparatus, and program for providing a personal color diagnosis platform using an image, through which it is possible to analyze a skin color of a user using a captured image of the user's face, diagnose a personal color matching the skin color, and provide the user with the diagnosed personal color.

### 2. Discussion of Related Art

A personal color is a personal color that matches a body and face color of an individual to make an individual look lively and energetic.

When the personal color matches the body color, the personal color may create an image that looks lively and energetic on the face, and create an image the person himself/herself wants, such as healthiness and balance.

On the other hand, when a personal color that does not match a unique body color of an individual is applied, the skin looks rough and the sense of transparency disappears, and thus elements, which are considered to be flaws on the face, such as the highlights of flaws on the skin, may be highlighted. As a result, individual images may be managed more efficiently by recognizing one's own body color and applying personal colors suitable for the body color in clothing, accessories, makeup, lens colors, and hair colors.

However, since it is difficult for individuals to objectively recognize and discover personal colors that match their own body colors, it is difficult for the individuals to determine the personal colors suitable for their body colors.

### SUMMARY OF THE INVENTION

The present invention provides a method, apparatus, and program for providing a personal color diagnosis platform using an image, through which it is possible to analyze a skin color of a user using a captured image of the user's face, diagnose a personal color matching the skin color, and provide the user with the diagnosed personal color.

Objects of the present invention are not limited to the above-mentioned objects. That is, other objects that are not mentioned may be obviously understood by those skilled in the art from the following description.

According to an exemplary embodiment, a method of providing a personal color diagnosis platform using an image, which is performed by a computing device, includes: acquiring a captured image of a user's face; dividing the face in the image; extracting a skin color of a designated area from the divided face; and extracting a color matching the user based on the extracted skin color.

The dividing of the face may include: extracting a plurality of feature points that become features of the face; and dividing the designated area based on the feature points.

The extracting of the color matching the user may include: quantifying the skin color extracted from the designated area using a pre-stored color system, and quantifying colors for yellowness and redness; quantifying saturation and lightness of the skin extracted from each of the plurality of areas using a pre-stored tone system; and extracting a representative skin color of the user from values obtained by quantifying the color, saturation, and lightness of the skin.

The method may include: dividing a dark circle area based on the plurality of feature points; extracting lightness of the dark circle area; determining a degree of severity of the dark circle based on the extracted lightness; and correcting a color matching the user by reflecting a result of the determination of the degree of severity of the dark circle.

The extracting of the color matching the user may include: extracting a first selected color that emphasizes or complements the yellowness of the representative skin color based on a practical color coordinate system (PCCS) color system; extracting a second selected color that emphasizes or complements the redness of the representative skin color based on the PCCS color system; and extracting a third selected color corresponding to lightness and saturation for emphasizing or complementing a tone of the representative skin color based on the PCCS tone system.

The extracting of the color matching the user may include: extracting an overlapping color having an attribute of the third selected color from the first selected color and the second selected color; providing the user with the extracted color as a best color: extracting a non-overlapping color having the attribute of the third selected color from the first selected color and the second selected color; and providing the user with the extracted color as a secondary color.

The method may further include: primarily classifying the first selected color and the second selected color into colors corresponding to four seasons; secondarily classifying the primarily classified color based on the third selected color according to the lightness and saturation; determining a type corresponding to a skin of the user according to the results of the primary classification and the secondary classification; and providing information on the color matching the user according to the determined type.

The method may further include: acquiring clothing information from a shopping mall; extracting at least one color included in clothing based on the clothing information; designating a representative color among at least one extracted color; and providing the user with clothing designated with a representative color included in the color matching the user.

According to another exemplary embodiment, an apparatus for providing a personal color diagnosis platform using an image includes: a memory configured to store one or more instructions; and a processor configured to execute the one or more instructions stored in the memory, in which the processor executes the one or more instructions to perform the method of providing a personal color diagnosis platform using an image.

According to still another embodiment of the present invention, there is provided a personal color diagnosis platform providing program using an image coupled to a computer which is hardware and stored in a computer-readable recording medium to execute the method of providing a personal color diagnosis platform using an image.

Other specific details of the invention are included in the detailed description and drawings.

### BRIEF DESCRIPTION OF THE DRAWINGS

FIG. 1 is a diagram illustrating a system for providing a personal color diagnosis platform using an image according to an embodiment of the present invention.

FIG. 2 is a hardware configuration diagram of an apparatus for providing a platform according to an embodiment of the present invention.

FIG. 3 is a diagram illustrating a method of providing a personal color diagnosis platform using an image according to an embodiment of the present invention.

FIG. 4 is a diagram illustrating a Lab color system according to an embodiment of the present invention.

FIG. 5 is a diagram illustrating a practical color coordinate system (PCCS) tone system according to an embodiment of the present invention.

FIG. 6 is a diagram illustrating a PCCS color system according to an embodiment of the present invention.

FIG. 7 is a diagram illustrating an example of the coordinate plane in which the areas are set according to the characteristics of the plurality of categories according to an embodiment of the present invention.

FIG. 8 is a diagram illustrating an example of specifying coordinate values for feature shapes according to an embodiment of the present invention.

FIG. 9 is a diagram illustrating an example of selecting a complementary adjective according to an embodiment of the present invention.

### DETAILED DESCRIPTION OF EXEMPLARY EMBODIMENTS

Various advantages and features of the present invention and methods of accomplishing them will become apparent from the following description of embodiments with reference to the accompanying drawings. However, the present invention is not limited to embodiments to be described below, but may be implemented in various different forms, these embodiments will be provided only in order to make the present invention complete and allow those skilled in the art to completely recognize the scope of the present invention, and the present invention will be defined by the scope of the claims.

Terms used in the present specification are for explaining embodiments rather than limiting the present invention. Unless otherwise stated, a singular form includes a plural form in the present specification. Throughout this specification, the terms “comprise” and/or “comprising” will be understood to imply the inclusion of stated constituents but not the exclusion of any other constituents. Like reference numerals refer to like components throughout the specification and “and/or” includes each of the components mentioned and includes all combinations thereof. Although “first,” “second,” and the like are used to describe various components, it goes without saying that these components are not limited by these terms. These terms are used only to distinguish one component from other components. Therefore, it goes without saying that a first component mentioned below may be a second component within the technical scope of the present invention.

Unless defined otherwise, all terms (including technical and scientific terms) used in the present specification have the same meanings commonly understood by those skilled in the art to which the present invention pertains. In addition, terms defined in commonly used dictionary are not ideally or excessively interpreted unless explicitly defined otherwise.

In this specification, a computer is any kind of hardware device including at least one processor, and can be understood as including a software configuration which is operated in the corresponding hardware device according to the embodiment. For example, the meaning “computer” may be understood to include all of smart phones, tablet PCs, desktops, laptops, and user clients and applications running on each device, but is not limited thereto.

Hereinafter, embodiments of the present invention will be described in detail with reference to the accompanying drawings.

Each step described in this specification is described as being performed by the computer, but subjects of each step are not limited thereto, and according to embodiments, at least some steps can also be performed on different devices.

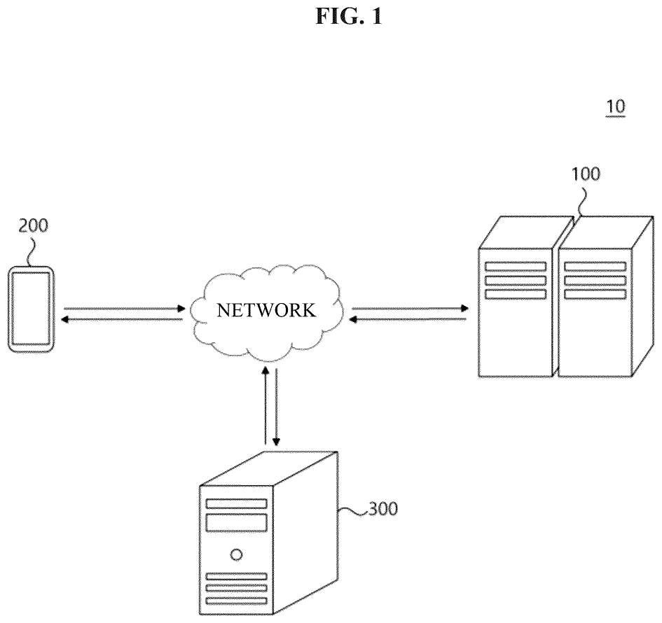

FIG. 1 is a diagram illustrating a system for providing a personal color diagnosis platform using an image according to an embodiment of the present invention.

Referring to FIG. 1, a system for providing a personal color diagnosis platform using an image according to an embodiment of the present invention may include an apparatus 100 for providing a platform, a user terminal 200, and an external server 300.

Here, the system for providing a personal color diagnosis platform using an image illustrated in FIG. 1 is according to an embodiment, and its components are not limited to the embodiment illustrated in FIG. 1, and may be added, changed, or deleted as necessary.

The system for providing a personal color diagnosis platform using an image according to an embodiment of the present invention may analyze a skin color of a face using a captured image of a user's face, analyze a color matching the skin color, and provide the user with the analyzed skin color. A user may receive a personal color diagnosis platform using an image through a user terminal 200, and provide the captured image of the face to the platform through the user terminal 200.

The apparatus 100 for providing a platform may acquire a captured image of a user's face, divide the face in the image, extract a skin color of a designated area from the divided face, and extract a color matching the user based on the extracted skin color.

The user terminal 200 may be connected to the apparatus 100 for providing a platform through a network, and may receive various services and platforms from the apparatus 100 for providing a platform.

The user terminal 200 may receive various services provided by the apparatus 100 for providing a platform through applications by downloading, installing, and executing applications related to various services and platforms provided by the apparatus 100 for providing a platform. To this end, the user terminal 200 may be equipped with an operating system capable of driving applications like a smart phone. However, the user terminal 200 is not limited thereto and may be equipped with other general-purpose devices capable of driving applications.

In various embodiments, the user terminal 200 may provide a service based on a web as well as an application, and a method of providing a service by the user terminal 200 is not limited to a specific format.

The external server 300 may be connected to the apparatus 100 for providing a platform through a network, and the apparatus 100 for providing a platform may store and manage various types of information for performing the method of providing a personal color diagnosis platform using an image.

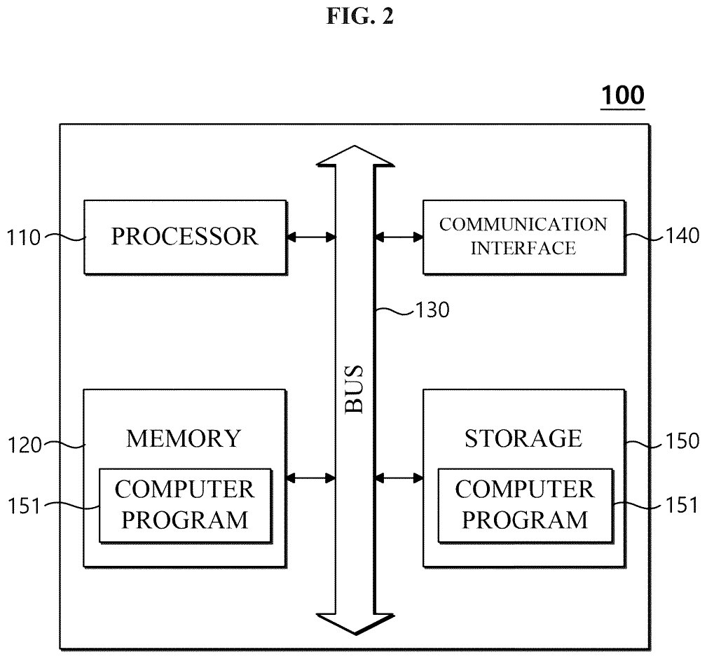

In addition, the external server 300 may receive and store various types of information and data generated as the apparatus 100 for providing a platform performs the method of providing a personal color diagnosis platform using an image. For example, the external server 300 may be a storage server provided separately outside the apparatus 100 for providing a platform. Referring to FIG. 2, a hardware configuration of the apparatus 100 for providing a platform will be described.

FIG. 2 is a hardware configuration diagram of an apparatus for providing a platform according to an embodiment of the present invention.

Referring to FIG. 2, the apparatus 100 for providing a platform (hereinafter, computing device) according to an embodiment of the present invention may include one or more processors 110, a memory 120 into which a computer program 151 executed by the processor 110 is loaded, a bus 130, a communication interface 140, and a storage 150 for storing the computer program 151. Here, only the components related to the embodiment of the present invention are illustrated in FIG. 2. Accordingly, those skilled in the art to which the present invention pertains may understand that general-purpose components other than those illustrated in FIG. 2 may be further included.

The processor 110 controls an overall operation of each component of the computing device 100. The processor 110 may be configured to include a central processing unit (CPU), a micro processor unit (MPU), a micro controller unit (MCU), a graphic processing unit (GPU), or any type of processor well known in the art of the present invention.

In addition, the processor 110 may perform an operation on at least one application or program for executing the method according to the embodiments of the present invention, and the computing device 100 may include one or more processors.

According to various embodiments, the processor 110 may further include a random access memory (RAM) (not illustrated) and a read-only memory (ROM) for temporarily and/or permanently storing signals (or data) processed in the processor 110. In addition, the processor 110 may be implemented in the form of a system-on-chip (SoC) including at least one of a graphics processing unit, a RAM, and a ROM.

The memory 120 stores various types of data, commands and/or information. The memory 120 may load the computer program 151 from the storage 150 to execute methods/operations according to various embodiments of the present invention. When the computer program 151 is loaded into the memory 120, the processor 110 may perform the method/operation by executing one or more instructions constituting the computer program 151. The memory 120 may be implemented as a volatile memory such as a RAM, but the technical scope of the present invention is not limited thereto.

The bus 130 provides a communication function between the components of the computing device 100. The bus 130 may be implemented as various types of buses, such as an address bus, a data bus, and a control bus.

The communication interface 140 supports wired/wireless Internet communication of the computing device 100. In addition, the communication interface 140 may support various communication methods other than the Internet communication. To this end, the communication interface 140 may be configured to include a communication module well known in the art of the present invention. In some embodiments, the communication interface 140 may be omitted.

The storage 150 may non-temporarily store the computer program 151. When the computing device 100 performs the method of providing a personal color diagnosis platform using an image, the storage 150 may store various types of information necessary to provide the method of providing a personal color diagnosis platform using an image.

The storage 150 may include a nonvolatile memory, such as a ROM, an erasable programmable ROM (EPROM), an electrically erasable programmable ROM (EEPROM), and a flash memory, a hard disk, a removable disk, or any well-known computer-readable recording medium in the art to which the present invention pertains.

The computer program 151 may include one or more instructions to cause the processor 110 to perform methods/operations according to various embodiments of the present invention when loaded into the memory 120. That is, the processor 110 may perform the method/operation according to various embodiments of the present invention by executing the one or more instructions.

In one embodiment, the computer program 151 may include one or more instructions to perform the method of providing a personal color diagnosis platform using an image that includes acquiring a captured image of a user's face, dividing the face in the image, extracting a skin color of a designated area from the divided face, and extracting a color matching the user based on the extracted skin color.

Operations of the method or algorithm described with reference to the embodiment of the present invention may be directly implemented in hardware, in software modules executed by hardware, or in a combination thereof. The software module may reside in a RAM, a ROM, an EPROM, an EEPROM, a flash memory, a hard disk, a removable disk, a compact disc read-only memory (CD-ROM), or in any form of computer-readable recording medium known in the art to which the invention pertains.

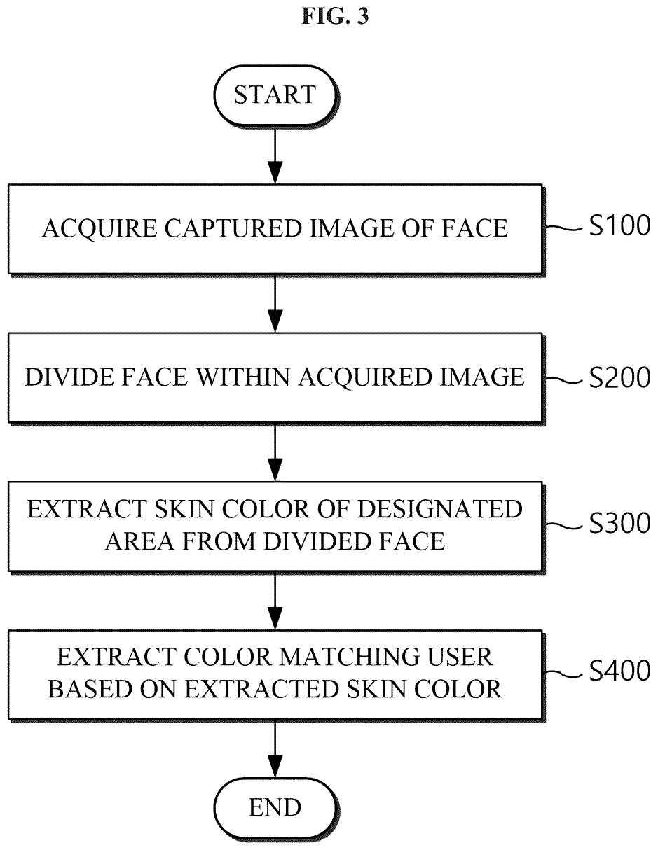

The components of the present invention may be embodied as a program (or application) and stored in a medium for execution in combination with a computer which is hardware. The components of the present invention may be executed in software programming or software elements, and similarly, embodiments may be realized in a programming or scripting language such as C, C++, Java, and assembler, including various algorithms implemented in a combination of data structures, processes, routines, or other programming constructions. Functional aspects may be implemented in algorithms executed on one or more processors. Hereinafter, the method of providing a personal color diagnosis platform using an image provided by the computing device 100 will be described with reference to FIG. 3.

FIG. 3 is a diagram illustrating the method of providing a personal color diagnosis platform using an image according to an embodiment of the present invention.

Referring to FIG. 3, the computing device 100 may acquire a captured image of a user's face (S100). The computing device 100 may provide instructions for operating a personal color diagnosis system using an image through the user terminal 200, and a user may provide a captured image of a face according to instructions provided through the user terminal 200 to the computing device 100.

The computing device 100 may provide an instruction for the user to capture an image of his/her face through the personal color diagnosis platform, and the user may capture an image of his/her own face according to the instruction. The image captured through the user terminal 200 may be provided to the computing device 100 through the personal color diagnosis platform.

Meanwhile, the computing device 100 may provide an instruction to upload the captured image to the personal color diagnosis platform, and the user may upload the captured image of the user's own face according to the instruction. The image uploaded through the user terminal 200 may be provided to the computing device 100 through the personal color diagnosis platform.

The computing device 100 may check the color and composition of the acquired image, request recapture of the image, or request upload of other images. For example, when an image is too bright or too dark, a user's face may not be properly recognized. Therefore, the computing device 100 may request that the image be recaptured or other images be uploaded to acquire the recognizable image of the user's face.

In addition, when the image of the user's face is captured from too far away or too close, the user's face may not be properly recognized. Therefore, the computing device 100 may request that the image be recaptured or other images be uploaded to acquire a recognizable image of the user's face.

In addition, when there is much yellowness, redness, greenness, or blueness in an image, since a skin color of a user may not be accurately analyzed, the computing device 100 requests that an image be recaptured or another image be uploaded, so that it is possible to acquire an image through which a user's accurate skin color can be recognized.

In addition, when a difference in color between both cheeks or both dark circles is severe, since the skin color of the user may not be accurately analyzed, the computing device 100 requests that the image be recaptured or another image be uploaded, so that it is possible to acquire an image through which the user's accurate skin color can be recognized.

In addition, when only a part of a user's face is captured in an image, the user is not looking forward or an image of a face is captured from too far away or too close, the computing device 100 requests that an image be recaptured or another image be uploaded, so that it is possible to acquire the recognizable image of the user's face.

The computing device 100 may divide a face in the acquired image (S200). The computing device 100 may extract feature points that become features of a face in an image. Feature points that become facial features may include all points that may define a face, such as corners of the eyes, pupils, the tip of the nose, the bridge of the nose, the heads of the eyebrows, the tails of the eyebrows, the chin line, the forehead line, the lips, the philtrum, and the glabella. In various embodiments, the computing device 100 may extract a plurality of feature points from a face using a preset landmark detection method, but is not limited thereto.

In various embodiments, the computing device 100 may divide facial features based on feature points. For example, the computing device 100 may determine positions and shapes of the eyes based on reference points set at the corners of the eyes, the pupils, and the eyelids, and thus it may be possible to distinguish the facial features.

In addition, the computing device 100 may divide a designated area for color determination based on feature points. For example, the designated area may be a specific area corresponding to a cheek within the face, but is not limited thereto.

Also, the computing device 100 may determine facial features using the set reference points. The computing device 100 may acquire a reference point group designating each facial feature. For example, the computing device 100 may generate one reference point group by extracting reference points defining the eyes. That is, the computing device 100 may generate one group including reference points designating the eyes, such as the corners of the eyes, the pupils, the eyelids, and eyelashes. The computing device 100 may generate each reference point group including reference points corresponding to positions of the face, the eyes, the nose, and the mouth.

For example, the computing device 100 may acquire a reference point group designating each facial feature. For example, the computing device 100 may generate, as one reference point group (for example, G1) defining the eyes, reference points set at the corners of the eyes, the pupils, the eyelids, and eyelashes. Also, the computing device 100 may generate, as one reference point group (e.g., G2) defining an eyebrow, reference points set in the head of the eyebrow, the tail of the eyebrow, and the center of the eyebrow. Also, the computing device 100 may generate, as one reference point group (e.g., G3) defining the mouth, reference points set at both ends of the lips, mounds of the lips, and centers of the lips. In the above-described embodiment, only the generation of reference point groups for the eyes, the eyebrows, and the mouth is disclosed, but it is not limited thereto, and reference point groups may be created for all features of the face, such as the forehead, a face shape, and the nose.

Also, the computing device 100 may determine distances between reference points corresponding to a reference point group and positions of the reference points. For example, among the reference points included in the reference point group defining the eyes, by determining the distance between a reference point set at the corners of the eyes and a reference point set at the eyelashes, the distance between the reference points set above and below the eyes based on the pupils, and the like, it is possible to determine the shapes of the eyes, and by determining where the reference point group defining the eyes is positioned on the face, it is possible to determine the positions of the eyes. The computing device 100 may define the feature shape based on the determined result, and may be able to define the shapes and positions of all components that are features of the face, such as the eyes, the nose, a face shape, and the forehead line.

The computing device 100 may extract a skin color of a designated area from the divided face (S300).

In various embodiments, the computing device 100 may extract skin colors from a plurality of preset areas based on the divided features. For example, the computing device 100 may extract a skin color of a position corresponding to a cheek based on the divided features.

Here, the computing device 100 may designate an area of a specific width at a position corresponding to the cheek based on the feature point, and may extract a skin color within the designated area. The specific width may be previously set, may be set randomly, or may be set by connecting a plurality of feature points.

Here, the computing device 100 may extract the skin color of the preset part and extract a user's personal color based on the extracted skin color, or may extract the skin color from a plurality of parts and extract the user's personal color based on the extracted skin color. In this case, the computing device 100 may analyze the skin color (e.g., calculated by applying a preset formula or criterion to the plurality of skin colors) based on the result of extracting the plurality of extracted skin colors, extract the personal color of the user based on the analyzed skin colors, extract the personal color using a skin color of a reference part, and then correct the extracted personal color using skin colors of other parts. However, the present invention is not limited thereto.

The computing device 100 may extract a color matching a user based on the extracted skin color (S400). Specifically, the computing device 100 may quantify the skin colors extracted from each of the plurality of areas using a pre-stored color system, and quantify colors of yellowness and redness.

The pre-stored color system may be a Lab color system, and the Lab color system may be a color space that may substantially match a color difference that may be detected by the human eye and a color difference expressed numerically in a color space.

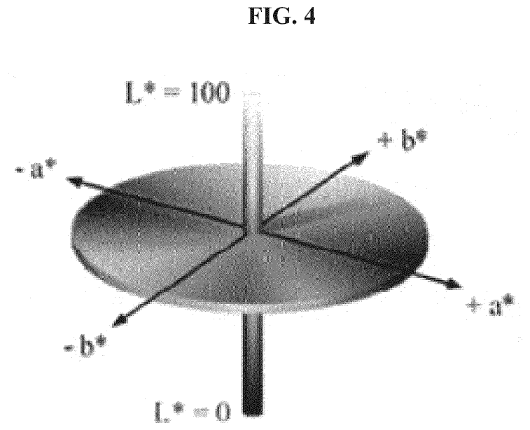

FIG. 4 is a diagram illustrating a Lab color system according to an embodiment of the present invention.

Referring to FIG. 4, the Lab color space is composed of three-dimensional solid coordinates and may be composed of L*, a*, and b* axes. L* means lightness. When L* is 100, it may mean a transparent color, and when L* is 0, it may mean an opaque color. L* may have a larger value as it goes in a + direction, and L* may have a smaller value it goes in a − direction.

In addition, a* indicates the degree of red and green, and the amount of red increases as it goes in the + direction and the amount of green increases as it goes in the − direction.

In addition, b* indicates the degree of yellow and blue, and the amount of yellow increases as it goes in the + direction and the amount of blue increases as it goes in the − direction. For example, a color with a*=80 may appear redder than a color with a*=50, and a color with b*=50 may appear yellower than a color with b*=20.

A color difference in this color space may be a three-dimensional distance between positions of two colors in a color space close to a sphere. That is, when the distance is far in three dimensions, a large color difference occurs, and when there is little difference between the distances, the same color may be perceived.

The computing device 100 may quantify colors for yellowness and redness of a skin color based on the Lab color system. That is, it is possible to extract an a* value having a + value and a b* value having a + value.

According to an embodiment of the present invention, the computing device 100 analyzes a color of human skin. Since the human skin basically has yellowness or redness, by quantifying only the colors for the yellowness and redness, it is possible to extract colors for human skin.

Referring back to FIG. 3, the computing device 100 may quantify saturation and lightness of skins extracted from each of the plurality of areas using a pre-stored tone system. The computing device 100 may quantify the saturation and lightness of the skins extracted from each of the plurality of areas using a practical color coordinate system (PCCS) tone system.

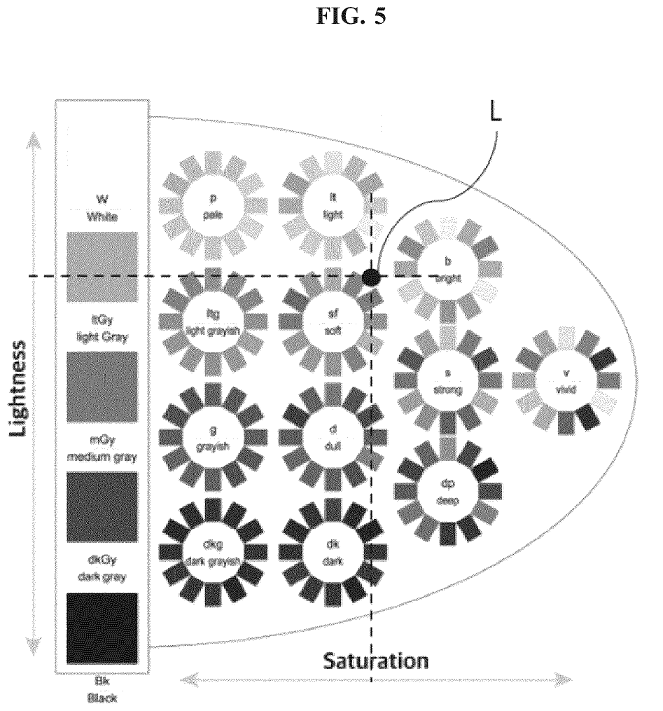

FIG. 5 is a diagram illustrating the PCCS tone system according to an embodiment of the present invention.

Referring to FIG. 5, in the PCCS tone system, an x axis may indicate saturation and a y axis may indicate lightness. That is, according to the drawing, colors with higher saturation, that is, colors that are not mixed with other colors, may be positioned from left to right, and colors with high lightness, that is, transparent colors, may be positioned from bottom to top.

The computing device 100 may quantify the saturation and lightness of the skins extracted from each of the plurality of areas based on the PCCS tone system. For example, in the PCCS tone system, the lightness of the y-axis and the lightness of human skin do not match. Since the skin of the Korean experimental group is not white or black like the y-axis range of the PCCS tone system, the personal color may be found by applying, as the PCCS y-value, a new y value corrected by matching the PCCS y axis to represent the lightness range of the skin color.

For example, the computing device 100 may determine a position L corresponding to the lightness and saturation of the skin and determine a tone at a position closest to the corresponding position L. For example, the computing device 100 may determine “sf” at a position closest to the position L as a tone corresponding to the saturation and lightness of the skin. However, the present invention is not limited thereto.

Referring back to FIG. 3, the computing device 100 may extract a color section matching values obtained by quantifying the color, saturation, and lightness of the skin according to the preset criteria according to the color, saturation, and lightness of the skin. The color section is a division of the color, saturation, and lightness of the skin according to a certain standard. For example, the yellowness and redness may be stored by being divided into 8 sections, the saturation may be stored by being divided into 5 sections, and the lightness may be stored by being divided into 10 sections.

The computing device 100 may extract the matching section using the quantified values according to the color, saturation, and lightness of the skin. Each color section may store a range of quantified values, and the color sections corresponding to a range of quantified values may be extracted.

The computing device 100 may extract a representative skin color of a user based on the color sections extracted for each of the plurality of areas. For example, the representative skin color may be derived by selecting at least one of colors corresponding to the extracted color sections or applying the preset formula or criterion to the plurality of color sections.

Here, extracting the color sections for the plurality of areas may be to more accurately extract a unique color representing a user's face by extracting skin colors from several areas since the skin colors may all be different in each user's face.

According to an embodiment of the present invention, the computing device 100 may classify a dark circle area based on the divided features or the plurality of feature points, and extract the lightness of the dark circle area. The computing device 100 may determine the degree of severity of the dark circle based on the extracted lightness. For example, the computing device 100 may determine that the dark circle is severe when the lightness of the dark circle is lower than the preset lightness, and determine that the dark circle is not severe when the lightness of the dark circle is higher than the preset lightness. However, the present invention is not limited thereto, and the degree of severity of dark circles is divided into several levels, with the lightness value designated for each level. Depending on the lightness of the dark circle of the user, the level according to the degree of severity of the dark circles may be determined.

The computing device 100 may correct the personal color value by reflecting the result of determining the degree of severity of the dark circle in a final personal color value. For example, when the dark circle of the user is not severe, the computing device 100 may diagnose the personal color of the user using the lightness determined according to the skin color of the user. For example, the lightness may be divided into five sections and assigned a level, and the lightness level may be reflected in the personal color diagnosis result of the user.

Meanwhile, when the dark circle of the user is severe, the computing device 100 may determine the lightness level of the user as an exceptional level instead of the above five sections. In this case, when the personal color of the user is diagnosed, the personal color diagnosis result of the user may be corrected by reflecting the exceptional level.

The computing device 100 may extract a first selected color that emphasizes or complements the yellowness of the representative skin color based on the PCCS color system. For example, the computing device 100 may select a color similar to yellow as the first selected color to emphasize the yellowness of the representative skin color, and select a color complementary to the yellowness as the first selected color to complement the yellowness of the representative skin color.

In addition, the computing device 100 may extract a second selected color that emphasizes or complements the redness of the representative skin color based on the PCCS color system. For example, the computing device 100 may select a color similar to red as the second selected color to emphasize the redness of the representative skin color, and select a color complementary to the redness as the second selected color to complement the yellowness of the representative skin color.

The computing device 100 may extract a third selected color corresponding the lightness and saturation that emphasizes or complements the tone of the representative skin color based on the PCCS tone system. For example, the computing device 100 may select the lightness and saturation of the tone similar to the lightness and saturation of the representative skin color for the third selected color, and select the lightness and saturation of the tone that may complement the lightness and saturation of the representative skin color for the third selected color.

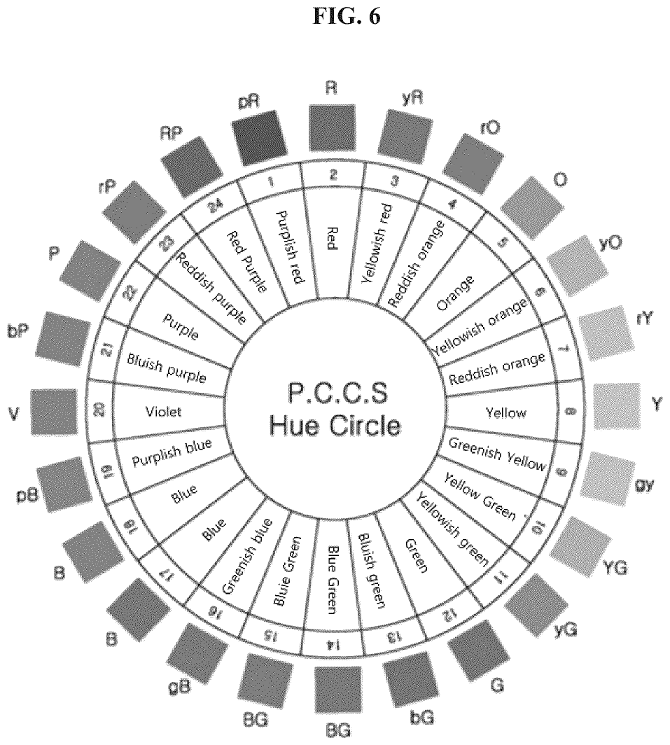

FIG. 6 is a diagram illustrating a PCCS color system according to an embodiment of the present invention.

Referring to FIG. 6, the PCCS color system is divided into 24 colors by putting colors corresponding to red, yellow, green, and blue in between, with similar colors placed on both sides of each color and complementary colors on the opposite side.

For example, in the operation of extracting a color matching a user, a process of determining a color that emphasizes or complements the features of the representative skin color of the user may be performed.

Referring back to FIG. 3, the computing device 100 may extract a color overlapping the first selected color and the second selected color among the third selected colors. That is, among the third selected colors, the color overlapping the first selected color and the second selected color may be a color that can be emphasized or complemented even if it corresponds to yellowness of skin, and can be emphasized or complemented even if it corresponds to redness. Accordingly, the computing device 100 may provide a best color user with a color extracted as the color overlapping the first selected color and the second selected color among the third selected colors. The computing device 100 may transmit the best color to the user terminal 200. In this case, the color tone may be expressed differently according to the screen setting of the user terminal 200. Accordingly, the user terminal 200 may provide a symbol, a number, or the like of a color corresponding to the best color to determine an exact color. In addition, when the best color is provided to the user terminal 200, the computing device 100 may automatically set a color tone, brightness, and the like of the screen of the user terminal 200 so that the color tone may be expressed well, and then provide the best color.

In addition, the computing device 100 may extract the color that does not overlap the first selected color and the second selected color among the third selected colors. That is, among the third selected colors, the color that does not overlap the first selected color and the second selected color may be a color that can be emphasized or supplemented according to the yellowness of the skin but cannot be emphasized or supplemented according to the redness of the skin, or may be a color that can be emphasized or supplemented according to the redness of the skin but cannot be emphasized or supplemented according to the yellowness of the skin.

However, since the color that does not overlap the first selected color and the second selected color is a color that may complement or emphasize at least one of the yellowness and the redness even if it may not complement or emphasize both the yellowness and redness, the computing device 100 may provide a user with the extracted color as the secondary color. The computing device 100 may transmit the secondary color to the user terminal 200. In this case, the color tone may be expressed differently according to the screen setting of the user terminal 200. Accordingly, the user terminal 200 may provide a symbol, a number, or the like of the color corresponding to the secondary color to determine an exact color. In addition, when the secondary color is provided to the user terminal 200, the computing device 100 may automatically set a color tone, brightness, and the like of the screen of the user terminal 200 so that the color tone may be expressed well, and then provide the secondary color.

According to an embodiment of the present invention, the computing device 100 may primarily classify the first selected color and the second selected color as colors corresponding to four seasons. The personal color is the color that best matches an individual's skin color, hair color, and pupil color. Recently, personal colors have been diagnosed using a classification system that classifies four seasons or more details in the classification of the four seasons.

For example, a warm tone and a cool tone may be divided according to the temperature sense of the skin color, with warm tones being classified into spring and autumn and cool tones being classified into summer and winter.

When the face color is bright yellow, it may be classified as a spring type, when the face color is yellowish skin with a whitish color and whitish and reddish skin with a bluish color, it may be classified as a summer type, when the face color is turbid and yellowish, it may be classified as an autumn type, and when the face color is reddish and transparent or a blue color with yellowness as a whole, it may be classified as a winter type. The computing device 100 may store colors corresponding to each type, and determine types corresponding to each of the colors corresponding to the first selected color and the second selected color to perform primary classification.

The computing device 100 may secondarily classify the color primarily classified based on the third selected color according to the lightness and saturation. The types corresponding to four seasons may be divided into light, mute, deep, and bright. The spring type is classified into light and bright, the summer type is classified into light, mute and bright, the autumn type is classified into mute and deep, and the winter type is classified into bright and deep.

This classification is made according to the lightness and saturation. The tone related to the lightness is light and deep. Light may be a color with high lightness as a bright pastel color with much white mixed in, and deep may be a color with low lightness as a dark color with much black mixed.

In addition, the tone related to saturation is mute and bright. Mute may be a color with low saturation as a grayish color mixed with gray, and bright may be a color with high saturation as a vivid color close to a pure color. The computing device 100 may store colors corresponding to each detailed type, and determine the corresponding type of each of the colors primarily classified based on the third selected color and perform the secondary classification.

The computing device 100 may determine a type corresponding to the user's skin according to the results of the primary classification and the secondary classification. The computing device 100 may determine the type corresponding to the user's skin as the most frequently included type among the classified types for colors completed up to the secondary classification. Alternatively, the computing device 100 may determine all the classified types for colors completed up to the secondary classification as the type corresponding to the user's skin.

The computing device 100 may provide information on a color that matches a user according to the determined type. The computing device 100 may store information on colors matching each determined type, extract a color for a type matching a user, and provide the extracted color to the user.

According to another embodiment of the present invention, the computing device 100 may diagnose adjectives corresponding to the user's facial mood using a result of determining the features of the face, and provide the diagnosed adjective to the user.

Specifically, the computing device 100 may set a plurality of categories according to images that may be divided according to a facial mood, and the plurality of categories may include a baby face image, a sophisticated image, a friendly image, and an activity image, but are not limited thereto.

The computing device 100 may match and store adjectives corresponding to each of the plurality of categories. That is, the computing device 100 may match and store “elegant,” “classy,” and “urban” as adjectives related to the sophisticated image, and match and store “cute” and “girlish” as adjectives related to the baby face image. Adjectives corresponding to each category may be set differently for each category, and may be set overlappingly as described above.

The computing device 100 may store categories and adjectives for each category, determine a corresponding category according to the feature of the face determined through the image, and diagnose the user's facial mood through the adjectives for each category.

That is, the computing device 100 may select categories corresponding to features of a face from among a plurality of categories. For example, as a result of analyzing the features of the face, when the face shape is round, a category for a baby face image may be selected. Meanwhile, as a result of analyzing the features of the face, if the corners of the eyes are drooping, the category for the friendly image may be selected. The computing device 100 may store categories for each feature of a face, and extract and select categories corresponding to the features. For example, the computing device 100 may store eyes with drooping corners as the features of the face corresponding to the category for the friendly image, and when the feature of the face is determined as the eyes with drooping corners through the image, may select the category as the friendly image.

Based on the adjectives included in the selected category, the computing device 100 may determine at least one of a representative adjective that most closely matches a user's facial mood, a reinforcing adjective that enhances the user's facial mood, and a complementary adjective that complements the user's facial mood. The computing device 100 may provide the determined adjective to the user.

Specifically, the computing device 100 may set a coordinate plane in which areas are set according to characteristics of a plurality of categories. Here, on the coordinate plane, a first category may be set in a first area having a large y value, a second category may be set in a second area having a small x value and a small y value, a third category may be set in a third area having a large x value, and a fourth category may be set in a fourth area having a large x value and a small y value.

However, the areas set on the coordinate plane for each category may not be limited to this, and according to an embodiment of the present invention, the areas according to the characteristics of the plurality of categories may be set in the first quadrant, but are not limited thereto. That is, the areas according to the characteristics of the plurality of categories may be set in the second quadrant, the third quadrant, and the fourth quadrant, and the sizes and positions of the areas according to the plurality of categories set in each quadrant may all be different.

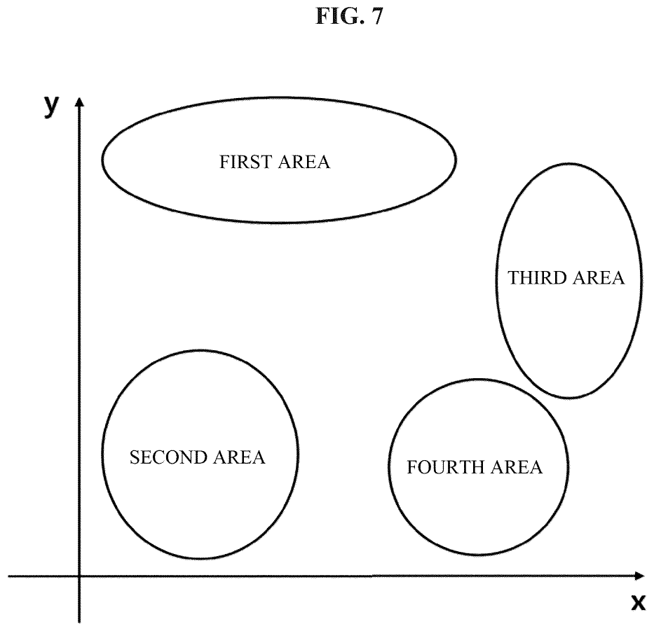

FIG. 7 is a diagram illustrating an example of the coordinate plane in which the areas are set according to the characteristics of the plurality of categories according to an embodiment of the present invention.

Referring to FIG. 7, the computing device 100 may set a first category in a first area having a large y value, set a second category in a second area having a small x value and a small y value, set a third category in a third area having a large x value, and set a fourth category in a fourth area having a large x value and a small y value. However, the area designated according to each category is not limited thereto, and the size and position of each area may not be limited thereto.

In addition, each of the ranges of the first area, the second area, the third area, and the fourth area may be designated and set. In this case, the designated values may not be preset. For example, the first area may be designated as an area where the y value is 8 or greater, the second area may be designated as an area where the x value is less than 5 and the y value is less than 5, the third area may be designated as an area where the x value is 10 or greater, and the fourth area may be designated as an area where the x value is 7 or greater and the y value is less than 3. However, the ranges designated for each area are not limited thereto.

The computing device 100 may designate coordinate values of each adjective. Coordinate values of each adjective may be designated based on an area for each characteristic of the plurality of categories. For example, the adjective “cute” may be an adjective included in both a baby image and a friendly image. Meanwhile, when the category for the baby face images is set in the fourth area and the category for the friendly image is set in the third area, coordinate values with a large x value and a small y value may be designated for the adjective “cute.”

The computing device 100 may calculate an x value and a y value for each of the shapes of the defined features. The computing device 100 may calculate various indexes representing the shape and positional relationship of each of the features constituting the face using the reference point, and acquire x values and y values for the indexes. The computing device 100 may calculate x values and y values for each feature through a preset reference point among reference points included in each reference point group. For example, in the case of an eye droop index, an x value and a y value for the eye droop index may be calculated using reference points set for eyelids and reference points set for the corners of eyes.

The computing device 100 may specify coordinate values corresponding to the calculated x and y values on the coordinate plane. That is, the computing device 100 may specify coordinate values for the shapes of each feature on the coordinate plane in which the areas are set according to the characteristics of the plurality of categories. The computing device 100 may select a category positioned closest to the specified coordinate value. The computing device 100 may provide the selected category as a category corresponding to the user's facial mood. Here, the plurality of categories may be selected as the categories are selected for each feature shape. In this case, the computing device 100 may select the category selected as the largest number as the representative category. In addition, the computing device 100 may set a weight according to the feature shape, and select a category having the largest value according to the weight as the representative category.

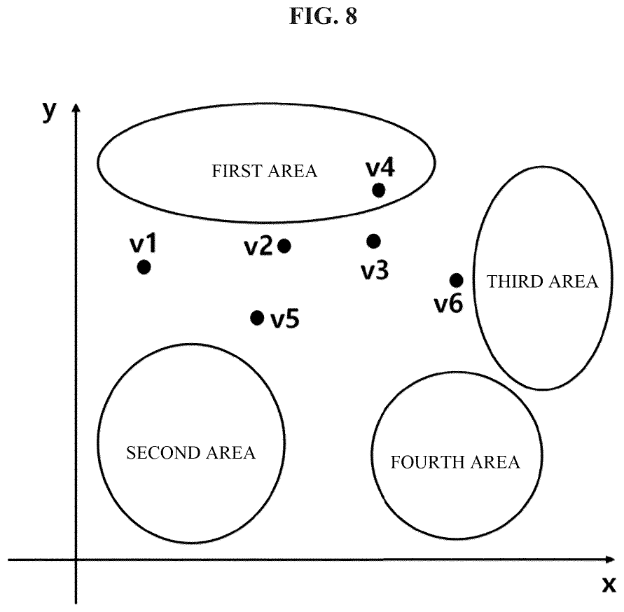

FIG. 8 is a diagram illustrating an example of specifying coordinate values for feature shapes according to an embodiment of the present invention.

Referring to FIG. 8, the computing device 100 may calculate various indexes representing the shape and positional relationship of each of the features constituting the face using the reference point, and acquire x values and y values for the indexes. The computing device 100 may specify the coordinate value v corresponding to the calculated x and y values on the coordinate plane. That is, the computing device 100 may specify the coordinate value v for each feature shape on the coordinate plane in which the areas are set according to the characteristics of the plurality of categories. The computing device 100 may select a category positioned closest to the specified coordinate value v. That is, the computing device 100 may select the first category designated in the first area closest to the coordinate values v1, v2, v3, and v4, select the second category designated in the second area closest to the coordinate value v5, and select the third category designated in the third area closest to the coordinate value v6.

The computing device 100 may select the first category selected as the largest number as the representative category. In addition, the computing device 100 may set a weight according to the feature shape, and select a category having the largest value according to the weight as the representative category.

The computing device 100 may extract adjectives corresponding to the selected category. The computing device 100 may extract adjectives whose x values or y values satisfy a specific criterion according to the characteristics of the category from among the extracted adjectives.

For example, when the selected category is the first category, the computing device 100 may extract adjectives having a y value greater than a specified coordinate value from among the adjectives included in the first category. In addition, when the selected category is the second category, the computing device 100 may extract adjectives having a y value smaller than the specified coordinate value from among the adjectives included in the second category. In addition, when the selected category is the third category, the computing device 100 may extract adjectives having an x value smaller than the specified coordinate value from among the adjectives included in the third category. In addition, when the selected category is the fourth category, the computing device 100 may extract adjectives having an x value smaller than the specified coordinate value from among the adjectives included in the fourth category.

The computing device 100 may provide the extracted adjective as the adjective corresponding to the user's facial mood.

In addition, the computing device 100 may rank the extracted adjectives in the order of a coordinate value of a position closest to a specified coordinate value among the plurality of adjectives extracted for each defined feature shape. Here, the coordinate value of the position closest to the specified coordinate value may be calculated through a formula for obtaining a distance between coordinates, and the extracted adjectives may be ranked in order of the adjectives with the smallest coordinate value of the calculated result value.

The computing device 100 may rank the adjectives for each category selected according to facial features, and provide the adjectives up to a specific place for each category to a user. For example, when the category selected according to features of a face is a baby face image and an activity image, the computing device 100 may rank the adjectives included in the baby face image and the adjectives included in the activity image. Thereafter, the computing device 100 may provide a user with adjectives corresponding to up to a third rank among the adjectives included in the baby face image, and provide a user with adjectives corresponding to up to the third rank among the adjectives included in the activity image.

Also, the computing device 100 may select representative adjectives based on the order of adjectives in each category. The representative adjective may be selected based on the highest ranked adjective in each category, and the adjective in the representative category or the adjective in the category having the highest value according to a weight may be selected as the representative adjective.

In addition, the computing device 100 may calculate x values and y values that are symmetrical about the x axis, the y axis, and the origin, based on the x values and the y values of the adjectives corresponding to the user's facial mood. The computing device 100 may select categories positioned closest to the coordinate values corresponding to the calculated x and y values, and provide a user with the selected categories or adjectives corresponding to the selected categories as a complementary adjective that complements the user's facial mood.

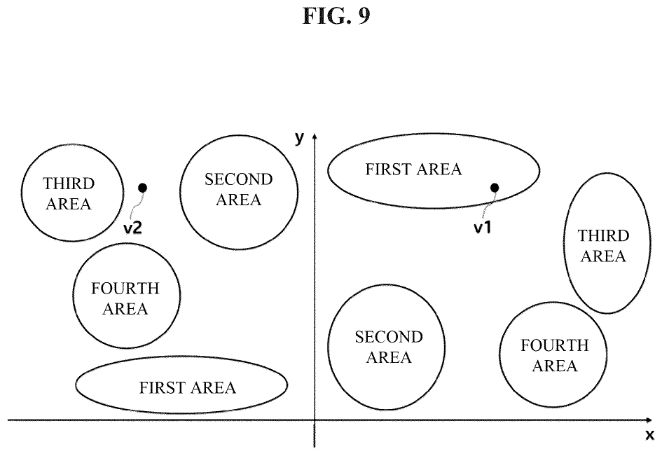

FIG. 9 is a diagram illustrating an example of selecting a complementary adjective according to an embodiment of the present invention.

Referring to FIG. 9, the computing device 100 may calculate x values and y values for each facial feature shape of the user and specify coordinates corresponding to the calculated x and y values on the coordinate plane. The computing device 100 may select a category set in an area positioned closest to a coordinate value v1 specified on the coordinate plane as a representative category, and determine adjectives included in the representative category as adjectives corresponding to a facial mood.

The computing device 100 may calculate a coordinate value v2 that is symmetrical about the specified coordinate value v1. The computing device 100 may calculate the coordinate value v2 that is symmetrical about the x axis, the y axis, and the origin. For example, when the x value of the specified coordinate value v1 is 10 and the y value is 12, the coordinate value v2 with the x value of 10 and the y value of −12, which are symmetrical about the x axis, may be calculated. In addition, when the x value of the specified coordinate value v1 is 10 and the y value is 12, the coordinate value v2 having the x value of −10 and the y value of 12, which are symmetrical about the y axis, may be calculated.

The sizes and positions of the areas for the plurality of categories set in each quadrant on the xy plane may all be different, and the categories at the positions closest to the symmetrical coordinate values v2 may also all be different. That is, when the coordinate value v1 specified in the first quadrant is symmetrical about the x axis, the coordinate value v2 that is symmetrical may be specified in the fourth quadrant, when the coordinate value v1 specified in the first quadrant is symmetrical about the y axis, the coordinate value v2 that is symmetrical may be specified in the second quadrant, and when the coordinate value v1 specified in the first quadrant is symmetrical about the origin, the symmetrical coordinate value v2 may be specified in the third quadrant. In this case, the categories closest to the coordinate values specified in the first quadrant, the second quadrant, the third quadrant, and the fourth quadrant may all be different. Meanwhile, it is possible that all the same categories are selected, and some of the same categories and some of the different categories can be selected.

The computing device 100 may select a category selected from the symmetrical coordinate values as a supplementary category, determine an adjective corresponding to the supplementary category as a supplemental adjective capable of complementing a facial atmosphere, and provide the determined adjective to the user.

According to an embodiment of the present invention, the computing device 100 may acquire clothing information from a shopping mall. The clothing information may acquire all information related to clothing, such as the shape, color, size, vendor, type, and fabric of clothing, but is not limited thereto.

The computing device 100 may extract at least one color included in clothing based on the acquired clothing information, and designate a representative color among the at least one extracted color. For example, the computing device 100 may designate a color most frequently included in the corresponding clothing as a representative color, or designate a color of a part (e.g., a sleeve end part, a neckline part, etc.) adjacent to skin as a representative color.

Also, the computing device 100 may determine representative mood information of clothing based on the acquired clothing information. For example, the computing device 100 may determine the mood of the clothing based on a variety of attribute information such as the style, type, and color of the corresponding clothing.

The computing device 100 may provide the clothing information to a user based on the degree of matching between the representative color of the designated clothing and the color matching the user. For example, the computing device 100 may provide clothing information in an order matching the user by processing three-dimensional distance information of a color matching the user and a representative color of clothing, but is not limited thereto.

For example, the computing device 100 may provide the user with clothing in which the representative color of the clothing matches the color extracted as the color matching the user. For example, when a bright beige color is extracted as the color matching the user, the computing device 100 may select clothing with the bright beige color designated as the representative color and provide the selected clothing to the user.

Also, the computing device 100 may provide the clothing information to the user according to the information matching the determined mode of the clothing and the user's mood. For example, the computing device 100 may process the 3D distance information between the user's mood and the mood of the clothing and provide the clothing information in the order in which it matches the user.

Alternatively, the computing device 100 may recommend clothing having a different mood that may complement the user's mood. For example, the user's mood may be enhanced by recommending clothing that matches the user's mood, but the user's mood may be changed differently by recommending clothing with a different mood from the user's mood.

As described above, according to an embodiment of the present invention, it is possible to realize the method of providing a personal color diagnosis platform using an image, device, and program that analyze the user's skin color using the captured image of the user's face, diagnose the personal color matching the skin color and provide the diagnosed personal color to the user.

According to the present invention, it is possible to analyze a skin color of a user using a captured image of the user's face, diagnose a personal color matching the skin color, and provide the user with the diagnosed personal color.

The effects of the present invention are not limited to the above-described effects, and other effects that are not mentioned may be obviously understood by those skilled in the art from the following description.

Although exemplary embodiments of the present invention have been described with reference to the accompanying drawings, those skilled in the art to which the present invention belongs will appreciate that various modifications and alterations may be made without departing from the spirit or essential feature of the present invention. Therefore, it is to be understood that the embodiments described hereinabove are illustrative rather than being restrictive in all aspects.

What is claimed is:

1. A method of providing a personal color diagnosis platform using an image, which is performed by a computing device, the method comprising:
acquiring a captured image of a user's face;
dividing the face in the image;
extracting a skin color of a designated area from the divided face; and
extracting a color matching the user based on the extracted skin color.

2. The method of claim 1, wherein the dividing of the face includes:
extracting a plurality of feature points that become features of the face; and
dividing the designated area based on the feature points.

3. The method of claim 2, wherein the extracting of the color matching the user includes:
quantifying the skin color extracted from the designated area using a pre-stored color system, and quantifying colors for yellowness and redness;
quantifying saturation and lightness of the skin extracted from each of the plurality of areas using a pre-stored tone system; and
extracting a representative skin color of the user from values obtained by quantifying the color, saturation, and lightness of the skin.

4. The method of claim 3, further comprising:
dividing a dark circle area based on the plurality of feature points;
extracting lightness of the dark circle area;
determining a degree of severity of the dark circle based on the extracted lightness; and
correcting a color matching the user by reflecting a result of the determination of the degree of severity of the dark circle.

5. The method of claim 3, wherein the extracting of the color matching the user includes:
extracting a first selected color that emphasizes or complements the yellowness of the representative skin color based on a practical color coordinate system (PCCS) color system;
extracting a second selected color that emphasizes or complements the redness of the representative skin color based on the PCCS color system; and
extracting a third selected color corresponding to lightness and saturation for emphasizing or complementing a tone of the representative skin color based on the PCCS tone system.

6. The method of claim 5, wherein the extracting of the color matching the user includes:
extracting an overlapping color having an attribute of the third selected color from the first selected color and the second selected color;
providing the user with the extracted color as a best color:
extracting a non-overlapping color having the attribute of the third selected color from the first selected color and the second selected color; and
providing the user with the extracted color as a secondary color.

7. The method of claim 5, further comprising:
primarily classifying the first selected color and the second selected color into colors corresponding to four seasons;
secondarily classifying the primarily classified color based on the third selected color according to the lightness and saturation;
determining a type corresponding to a skin of the user according to the results of the primary classification and the secondary classification; and
providing information on the color matching the user according to the determined type.

8. The method of claim 1, further comprising:
acquiring clothing information from a shopping mall;
extracting at least one color included in clothing based on the clothing information;
designating a representative color among the at least one extracted color; and
providing the user with clothing designated with a representative color included in the color matching the user.

9. An apparatus for performing the method of claim 1, comprising:
a memory configured to store one or more instructions; and
a processor configured to execute the one or more instructions stored in the memory,
wherein the processor executes the one or more instructions to perform the method of claim 1.

10. A recording medium readable by a computing device on which a program for performing a method of claim 1.
